(19) United States
(12) Patent Application Publication
(10) Pub. No.: US 2023/0241833 A1
(43) Pub. Date: Aug. 3, 2023

(54) POSITIVE DISPLACEMENT PUMP MATERIAL DELIVERY SYSTEM FOR ADDITIVE MANUFACTURE

(71) Applicants: Michael E. Mackay, Middletown, DE (US); Zachary Swain, Newark, DE (US)

(72) Inventors: Michael E. Mackay, Middletown, DE (US); Zachary Swain, Newark, DE (US)

(73) Assignee: University of Delaware, Newark, DE (US)

(21) Appl. No.: 18/131,669

(22) Filed: Apr. 6, 2023

Related U.S. Application Data
(63) Continuation of application No. PCT/US2021/053974, filed on Oct. 7, 2021.
(60) Provisional application No. 63/089,718, filed on Oct. 9, 2020.

(51) Int. Cl. B29C 64/106; B29C 64/321; F04C 2/18; F04C 13/00

(52) U.S. Cl. CPC B29C 64/106; B29C 64/321; F04C 2/18; F04C 13/001; B33Y 10/00

(57) ABSTRACT

A positive displacement pump for an additive manufacture application includes a motor having a rotatable output shaft, at least one rotatable gear or rotatable screw that is attached to the output shaft of the motor, and a passage defined downstream of said at least one rotatable gear or rotatable screw. The gear or screw is configured to receive material, and expel the material out of the pump at a flow rate proportional to a rotation rate of the output shaft of the motor and at a constant flow rate for a fixed rotation rate of the output shaft regardless of changes in system pressure.

### CROSS-REFERENCE TO RELATED APPLICATION

This application is a continuation of U.S. National Phase Application of PCT International Application PCT/US2021/053974, filed Oct. 7, 2021, which application claims priority to U.S. Provisional App. No. 63/089,718, filed Oct. 9, 2020, both of which are incorporated by reference herein in their entireties.

### STATEMENT REGARDING FEDERALLY SPONSORED RESEARCH

This invention was made with government support under Grant No. W911NF-20-2-0069 awarded by the U.S. Army Research Laboratory. The government has certain rights in the invention.

### FIELD OF THE INVENTION

This invention is generally related to a pump used in additive manufacture. More specifically, the pump operates as a positive displacement pump that can receive, seal, and pump material through an optionally heated outlet where it is deposited to form an object.

### BACKGROUND OF THE INVENTION

The history of Additive Manufacture (AM) started in the 1980's with stereolithography as described by Hull in U.S. Pat. No. 4,575,330. Following that, a new technique was invented where molten plastic was added to an ever growing substrate by a moving hot end. This system, as described by Crump in U.S. Pat. No. 5,121,329, uses a fiber of solid plastic as the feedstock. The feedstock is forced into a heated housing where it is heated (and optionally melted) and pushed through a nozzle having an exit diameter much smaller than the housing diameter. A seal is made between the solid fiber and housing with molten plastic to allow pressure build-up so that the plastic material can be pushed through the nozzle. It is this system that the present invention generally relates.

The fiber feed system works well for some but not all plastics. For example, very soft plastics cannot be forced into the heated housing since the fiber buckles through what is called a Euler instability. On the other hand, very brittle plastics also do not work well since they cannot be wound onto a spool, which is the preferred method to store and use the feedstock. In addition, some plastics are temperature sensitive so that their properties become poor after multiple extrusions, such as that required to made the feedstock fiber. This limitation, in addition to the necessity of using the fiber feedstock in general, has led to invention of a vertical, conical, single screw extruder as described in U.S. Pat. App. Pub. No. 2017/0291364 A1 by Womer (Womer, hereinafter). Womer's extruder is similar to a standard, horizontal, single screw extruder that has the outmost surface of the flight in near-close contact with the inner surface of the housing surrounding the screw. The conical screw also has the flight surface in near-close contact with the housing except that both are conically tapered. The taper allows standard pellets to be fed into the top of the vertical, conical screw due to the increased clearance between the inside of the housing and the root of the screw. After the pellets are fed into the screw/housing system they are conveyed down the length of the screw where they are heated and pressurized by the action of the screw and housing.

Both the standard, horizontal, single screw extruder and conical, vertical, single screw extruder take pellets in the initial feed zone, encompassing about 1 to 1.5 turns in the case of the vertical extruder, to a receiving zone, encompassing about 11 turns in the vertical extruder. The significant receiving zone length is required so the plastic can be successfully deposited. Due to the significant screw length in the vertical extruder, the entire system is still large. The size is modulated by using a conical screw allowing an overall shrinkage of the entire system while still allowing use of pellets due to the increased gap between the screw root and inner housing wall at the initial feed section. A single screw extruder operates by dragging fluid or other material forward by rotation of the screw, which is what makes the molten plastic (or other material) move forward and out of the nozzle. Movement of the plastic is opposed, however, by the pressure rise developed in the extruder as the material is pushed forward through the compression zone of the extruder (see, e.g., https://www.researchgate.net/figure/A-schematic-of-a-typical-single-screw-extruder_fig1_304090772). The pressure rise is required to push the material through the small hole of the nozzle. The pressure rise produces back-flow and makes the flow rate of material ejected from the extruder less than expected, i.e. the flow rate generated is not directly proportional to the rotation rate of the screw.

In view of the foregoing, it would be desirable to make the entire extruder smaller and lighter so manufacturing speed can be increased and to operate on small platforms/areas, yet, still have the ability to use pellets (or other types of feed stock) as the feed material. It would also be desirable to offer an AM machine in the form of a positive displacement pump that provides a flow rate of ejected material that is directly proportional to the rotation rate of the output shaft of the pump motor.

### SUMMARY OF THE INVENTION

According to one aspect of the invention, a positive displacement pump for an additive manufacture application comprises:
a motor having a rotatable output shaft;
at least one rotatable gear or rotatable screw that is attached to the output shaft of the motor; and
a passage defined downstream of said at least one rotatable gear or rotatable screw that is configured to receive material, and expel the material out of the pump at a flow rate proportional to a rotation rate of the output shaft of the motor and at a constant flow rate for a fixed rotation rate of the output shaft regardless of changes in system pressure.

According to one aspect of the invention, a positive displacement pump for an additive manufacture application is provided. The pump includes a motor having a rotatable output shaft. At least one rotatable gear or rotatable screw (or other mechanism) is attached to the output shaft of the motor. A passage is defined downstream of said at least one rotatable gear or rotatable screw that is configured to receive material and expel material out of the pump at a flow rate proportional to a rotation rate of the output shaft of the motor and at a constant flow rate for a fixed rotation rate of the output shaft regardless of changes in system pressure. The material may or may not be heated or melted in the passage.

According to yet another aspect of the invention, a method of additive manufacture using the positive displacement pump is provided. The method comprises:
introducing material onto or into said at least one rotatable gear or rotatable screw;
rotating said at least one rotatable gear or rotatable screw to deliver the material into the passage;
heating the material within passage (optional step); and
expelling the material out of the pump at a flow rate proportional to a rotation rate of the output shaft of the motor and at a constant flow rate for a fixed rotation rate of the output shaft regardless of changes in system pressure.

Again, the material may or may not be heated or melted in the passage.

### BRIEF DESCRIPTION OF THE DRAWING FIGURES

FIG. 1 depicts a sectional view of a positive displacement pump having a motor and screw arrangement for use in an AM application, according to a first exemplary embodiment of the instant invention.

FIG. 2 depicts a side elevation view of the conical screw and the motor of FIG. 1.

FIG. 3 depicts a sectional view of another positive displacement pump, in the form of a gear pump, for use in an AM application, according to a second exemplary embodiment of the instant invention.

FIG. 4 is a graph depicting mass flow rate of extruded plastic in relation to feed interval time.

FIG. 5 is a graph depicting mass flow rate of extruded plastic in relation to the rotational speed of the screw of the pump of FIG. 1.

It should be understood that the dimensions shown in the figures do not limit the scope of the instant invention.

### DETAILED DESCRIPTION OF THE INVENTION

This invention will now be described with reference to several embodiments selected for illustration in the drawings. It will be appreciated that the scope and spirit of the invention are not limited to the illustrated embodiments.

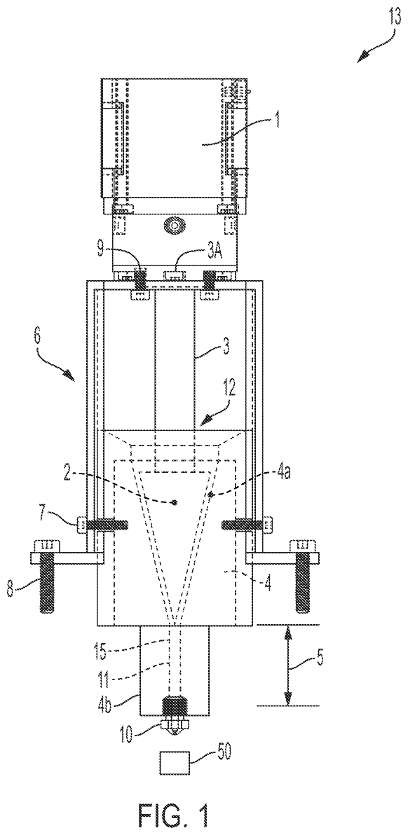

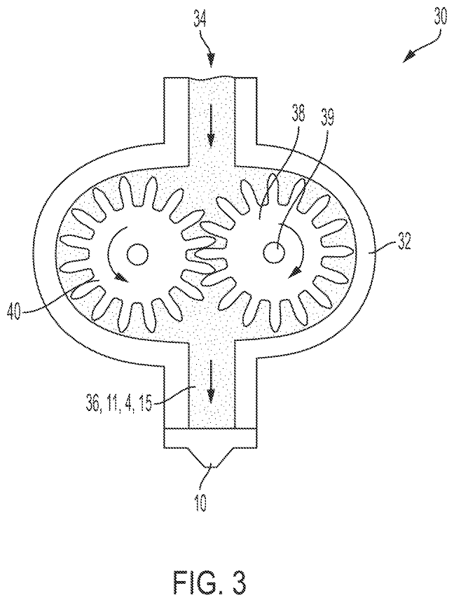

FIGS. 1 and 3 depict positive displacement pumps for use in an AM application. A positive displacement pump provides a constant flow of material at fixed operating speed, regardless of changes in pressure. Stated differently, a positive displacement pump provides a flow rate of ejected material that is directly proportional to the rotation rate of the motor shaft of the pump motor. The pump makes the fluid move by trapping a fixed amount of fluid and forcing the volume of fluid into a discharge area.

Turning now to FIG. 1, that figure depicts a positive displacement pump 13 having a motor and screw arrangement, for use in an AM application and according to a first exemplary embodiment of the invention. Pump 13 is configured to pressurize (and optionally heat and/or melt) material, such as plastic pellets, for use in AM. Pump 13 may be configured to output 0.1 to 1 lbs per hour of plastic product, for example.

Pump 13 comprises a frame 6 to which a motor 1 and housing 4 are mounted. Housing 4 may also be referred to in the art as a barrel. Pump 13 may be less than 15 inches in length, and preferably 6 to 10 inches in length, for example. Center-lines of motor 1 and housing 4 are aligned. Bolts 7 and 9 mount motor 1 and housing 4 to frame 6. Bolts 8 secure the pump 13 to another object, such as an AM instrument (not shown).

A screw 2 is non-rotatably attached to the motor shaft 3A by a coupling 3. Screw 2 is also aligned along the center line. The housing 4 has a conical bore, as depicted by the phantom lines in FIG. 1. Screw 2 is positioned at least partially within the conical bore 4a of housing 4. It is noted that the conical bore can be modified if screw 2 has a small gap at its exit. Such a small gap allows pressurization through positive material flow rate. A guide 12, which may be conical, guides material toward screw 2. Guide 12 is positioned at an elevation above housing 4. A material receiving zone 11 is disposed in a cylindrical passage 15 extending through the small diameter end of housing 4. Zone 11 of passage 15 has a length 5 that is sized so that the material, which may or may not be heated or molten, reaches a pre-determined temperature prior to entering the nozzle or die 10 at the exit of housing 4. A band heater may be positioned around the circumference of the small diameter end 4b of housing 4 for heating that portion of housing 4 (in addition to other areas of the housing). Alternative means for heating are envisioned, such as heating elements or heating coils mounted near passage 15, for example.

As another alternative, the passage 15 described herein may not be heated at all. A separate device 50 may be provided for solidifying the material expelled from the outlet of passage 15 (i.e., the nozzle). For example, device 50 may be one of a (i) UV emitter, radiation emitter or light source positioned at the outlet of the passage 15 for curing the material expelled from the outlet of the passage 15, (ii) a means positioned at the outlet of the passage 15 for cooling or freezing the expelled material, (iii) a heater or heated substrate positioned at the outlet of the passage which may or may not cure and/or solidify the material, and (iv) a gas source positioned after the exit of passage 15 (and optionally after the exit of the nozzle) causing the material to solidify and/or cure.

The materials fed into pump are not necessarily limited to plastic that originates in pellet form. The material may be a slurry or paste, for example. The material may foam, for example, upon exiting nozzle 10.

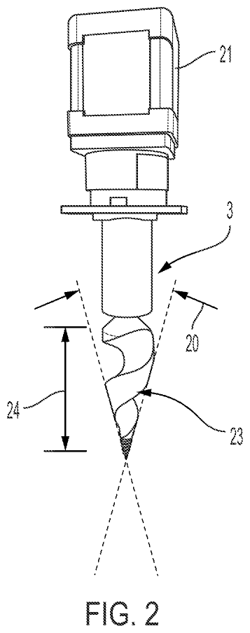

FIG. 2 depicts motor 1 and screw 2 attached to motor shaft 3A of motor 1. Screw 2 may have 1 to 4 turns, and, preferably, 1 to 2 turns. The screw length 24 may be 2.25 inches, for example. The upper diameter of screw 2 may be 1 inch, for example. The conical angle of the internal bore of the housing 4 compliments and corresponds to the conical angle 20 of screw 2 such that near-close contact is made between housing 4 and screw 2. Conical angle 20 may be 12 degrees, for example. The gap between the screw 2 and the internal bore of the housing 4 is approximately about 0.001 inches to 0.05 inches. This gap either prevents or limits the loss of throughput by leakage, especially near the exit of screw 2 since this region can be exposed to the highest pressure. The gap between the screw 2 and the inner bore of housing 4 can be adjusted depending on the rheological properties of the material being processed by pump 13, and the size of potential, solid fillers within the material. This gap may form a melt seal. It should be understood that all of the above-identified dimensions can vary.

Briefly, in operation, pellets (or other form of material) are fed into guide 12 of pump 13, and are directed into the space between screw 2 and housing 4. Screw 2, which is rotated by motor 1, moves pellets toward passage 15. At this stage, for a heated pump housing, the pellets may be softened, but may not have yet reached their desired final processing temperature (which may be a melting temperature) before entering passage 15. Stated differently, the vast majority of the material may not be fully heated to its desired final processing temperature when it is in contact with or being transported by screw 2 (unlike Womer's device). It is noted, however, that the material may nor may not be capable of melting, and the material may or may not be plastic. Also, the material may not be heated at all.

As noted above, Womer's device experiences pressure driven backflow of liquid plastic on the screw, which results in a non-positive displacement method of conveying the liquid plastic. In contrast, in the pump 13, the material enters passage 15, and are fully heated (and possibly melted) therein, by heating, pressure, or a combination of both. The fully heated material (which may or may not be melted depending upon the particular application) is ejected through nozzle 10. The flow rate of ejected material is directly proportional to the rotation rate of screw 2. Pump 13 does not experience pressure driven backflow of material which would result in a non-proportional ejection rate.

The geometry of the components of pump 13 can be scaled to other applications requiring either a faster or slower volumetric flow rate. For example, a larger screw 2 will extrude more material per unit time. The other dimensions will be similarly scaled for larger or smaller volumetric flow rates. The gaps between the metal surfaces, however, can or should remain as described above in order to form a material seal.

This invention is not limited to use of screw 2 that operates as a positive displacement pump. Since substantial melting and plasticization is not required for the pump's operation, other types of suitably modified positive displacement pumps can be used. Such examples of positive displacement pumps include: lobe pumps, gear pumps, rotary vane pumps and the like. A gear pump is one such example and is discussed in greater detail below.

FIG. 3 depicts another positive displacement pump in the form of a gear pump 30 for use in an AM application and according to a second exemplary embodiment of the invention. Common features between the two embodiments have the same reference characters. And, unless stated herein, all of the features of the pump of FIG. 1 are relevant to pump 30 of FIG. 3.

Gear pump 30 includes a housing 32 defining a hollow interior section, an inlet 34 though which pellets (or other types of material feed stock) are introduced, and an outlet 36 through which material is expelled. Two gears are positioned within the interior section. More particularly, a first driver gear 38 is rotatably mounted within the interior section. The motor shaft 3A (not shown in this view) is connected to the shaft 39 of gear 38 for rotating gear 38. A second driven gear 40 is also rotatably mounted within the interior section. The teeth of gears 38 and 40 are meshed such that rotation of gear 38 causes rotation of gear 40 in an opposite rotational direction. The feedstock material is ultimately expelled under pressure from outlet 36 of housing 32 and through nozzle 10.

Like the pump of FIG. 1, the gear pump 30 can form a material seal (i) between the gears 38 and 40, and (ii) between the gears 38 and 40 and the interior facing walls of the hollow interior of housing 32. Similar tolerances for the gap apply for this type of pump, and other positive displacement pumps.

Referring now to both the first and second embodiments, in use, pellets (or other feedstock) are conveyed forward by the action of the pump placing them into the receiving zone (RZ) of passage 15 after leaving the end of screw 2 or outlet of gear pump 36. One purpose of the RZ is to thermally homogenize the temperature of the material. This may be accomplished by heating the RZ with a band heater, or similar, to the desired temperature. Nozzle 10 is placed after the RZ of passage 15 to control the extrudate diameter of an object used in AM.

The engineering calculation to find the average temperature (<T>) of the material at the end of a cylindrical receiving zone is found by using the equation given by Middleman (S. Middleman, “An introduction to mass and heat transfer,” John Wiley and Sons, New York (1998), equation (11.1.43))

$$\frac{{T}_{w} - 〈 T 〉}{{T}_{w} - {T}_{0}} = 0.692 exp ( - 5.78 \frac{α t}{{R}^{2}} ) \qquad ( 1 )$$

where T_{w} is the receiving zone wall temperature, T₀, the initial temperature entering the receiving zone, α, the thermal diffusivity of the material, t, the time the material spends in the RZ, and R, the inside radius of the RZ. The time the material is in the receiving zone is related to the volumetric flowrate, Q, of the material through

$$t = \frac{π {R}^{2}}{Q} L \qquad ( 2 )$$

where L is the receiving zone length (corresponding to length 5 in FIG. 1). Combining equations (1) and (2) yields

$$\frac{{T}_{w} - 〈 T 〉}{{T}_{w} - {T}_{0}} = 0.692 exp ( - 5.78 \frac{πα L}{Q} ) \qquad ( 3 )$$

The length 5 (L) of the receiving zone to achieve a given average temperature can be determined with equation (3) by rearranging it to

$$L = - \frac{1}{5.78 π} \frac{Q}{α} ln ( 1.45 \frac{{T}_{w} - 〈 T 〉}{{T}_{w} - {T}_{0}} ) \qquad ( 4 )$$

Consider 3D printing of poly(lactic acid) under typical conditions where Q would be approximately 10 mm³/s and a is about 0.1 mm²/s. If T_{w} is 210° C. and the initial temperature, T₀, is near room temperature at 25° C., and assuming the average temperature is to be within 5° C. of T_{w}, then the length L should be approximately 18 mm in length assuming good thermal contact along the entire RZ length and neglecting potential melting of the material, should the polymer be crystalline and softening of the solid polymer should it be amorphous.

This small length L, together with the small size of the pump, will lead to a compact extruder useful in AM. The instant invention allows achievement of larger volumetric flowrates, and thereby an increased manufacturing rate, while still being very small in overall size. Equation (4) demonstrates that as the volumetric flowrate is increased, the RZ length is similarly increased to promote the same average temperature at the end of the RZ.

In another embodiment, if the required flow rate is so large that the RZ length of passage 15 becomes too great for the AM equipment, then passage 15 can have a serpentine shape. This means the RZ of passage 15 can be aligned parallel to the direction of the screw axis (for example) conveying the material away from the end of the screw 2, then turn 180-degrees and convey the material towards the end of the screw 2, and so on to provide the required RZ length and to supply material to nozzle 10.

In yet another embodiment, passage 15 has a helical shape and the center axis of the RZ is a helix. Combinations of the serpentine and coiled designs can be used to increase the RZ length.

In still yet another embodiment, a static mixer is disposed into passage 15. The static mixer divides and recombines the material to help homogenize the material temperature. The mixer is not just useful to homogenize the temperature in a polymer melt (for example). The mixer could also be used to thoroughly mix pre-polymer and a curing agent, for example. These devices are familiar to those trained in the art of polymer extrusion and are used for this purpose.

The pumps described herein include a rotational input in the form of a motor. The motor is directly attached to a shaft attached to a screw, gear or impeller and aligned along its axis or by a gear or pulley motor mechanism that also rotates the shaft.

Full temperature achievement of the set-point temperature does not substantially occur within the pump free volume, since it is so small. The RZ is (optionally) heated and, since material will be in thermal contact with the end of the screw, it will increase in temperature with time until, eventually, a steady state temperature may be attained. After leaving the RZ of passage 15, the material is forced by pressure through nozzle 10 to be deposited onto an ever growing substrate that is the product of AM. The pump pressurizes the material in the RZ.

Extruders, such as the vertical extruder in US Pat. No. 2017/0291364 by Wormer, have a specifically designed “compression ratio” to cause pressurization. The compression ratio is the volume of material in the initial turn of the helical channel in the screw divided by the volume of material in the final turn of the screw at the exit. This ratio is preferable between 3 to 7.

There is no specifically designed compression ratio in the instant invention, however. It is the positive mass flow rate injected into the RZ that causes pressurization. The material seal formed at the end of the pump allows the pressure to increase when material is fed forward into the RZ.

### Example

The positive displacement (PD) pump of FIG. 1 described above was attached to a Three Dimensional (3D) Printer, a Lulzbot Taz 4, and the motor electrically connected so the printer software could control the screw rotation.

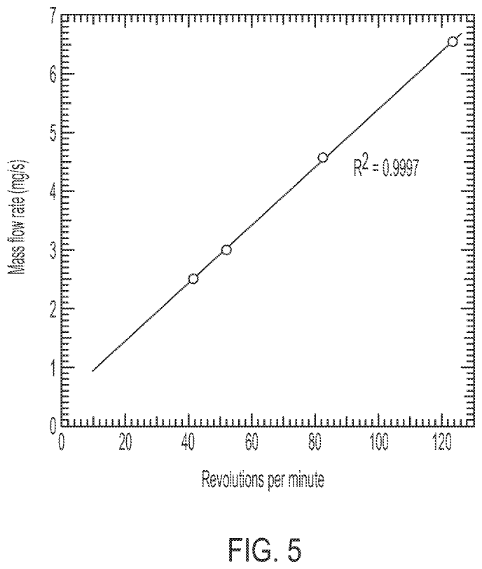

Poly(lactic acid) or PLA was obtained from Village Plastics in pellet form and used as-is. Operating at a given RPM, the feed rate was incrementally increased. The output mass flow rate exiting the nozzle was measured at each increment. When a high enough feed rate was reached whereby any faster feed rates resulted in a constant mass flow rate exiting the nozzle, then this was found to be the total displacement rate (e.g., mass flow rate) at that operating RPM. The mass flow rate as a function of RPM's at the operating point is shown in FIG. 5.

The weight of 25 PLA pellets was determined to be 1083.7 mg making the average weight of one pellet equal to 43.35 mg.

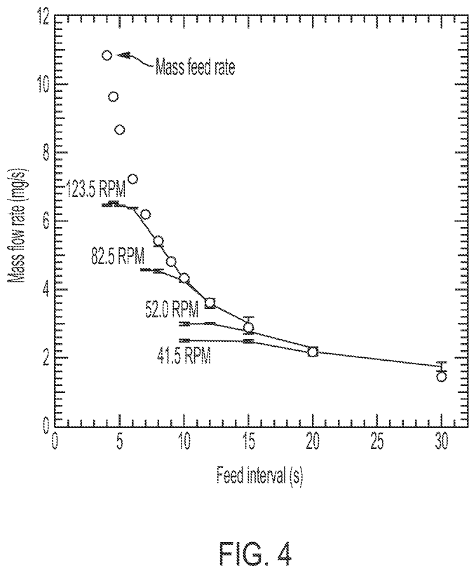

A hopper was used to feed a single pellet at a given Feed interval as shown by the unfilled circles in FIG. 4 and labelled as the Mass feed rate in that figure. The Mass feed rate was determined by dividing the mass of a single pellet by the Feed interval. In the figure the Mass feed rate is plotted on the same axis as the Mass flow rate.

The screw of the pump was turned at various Revolutions Per Minute (RPM) for a given Feed interval. And, the Mass flow rate exiting the nozzle was determined by taking the average of at least four samples. The sample was made by using a knife to cut off the fiber exiting the nozzle. At the same time, a timer was simultaneously started. An ensuing fiber was formed and cut after approximately 20 to 30 seconds. The timer was simultaneously stopped and the sample collected and weighed. The Mass flow rate exiting the pump was determined by dividing the sample mass collected by the time displayed by the timer. At least four samples were taken at each Feed interval. An average and standard deviation were determined for the measured mass flow rates. Screw RPM was determined by an optical tachometer. The Mass flow rate in FIG. 4 is represented by a dot with the standard deviation represented as two small lines above and below the dot. The standard deviation is small showing the steady flow produced by the pump of FIG. 1.

At the operating point, the Mass flow rate was essentially linear with RPM's, as shown in FIG. 5, since the correlation coefficient (R²) was very close to one (0.997). A correlation coefficient of exactly one indicated a perfect linear relation between Mass flow rate and RPM's.

In some PD pumps the relation is not linear, unlike that shown in FIG. 5, as there is back flow of liquid particularly at larger Mass flow rates rather than small Mass flow rates. This is referred to as Slip in the pumping literature which should be known to those skilled in the art. A single screw plasticating extruder also does not have a linear relation between the Mass flow rate and RPM's. This is known to those skilled in the art and is discussed in the textbook by Tadmor and Gogos (Tadmor, Z. & Gogos, C. G. Principles of polymer processing, 2nd edition. (John Wiley and Sons, 2006)).

Although the invention is illustrated and described herein with reference to specific embodiments, the invention is not intended to be limited to the details shown. Rather, various modifications may be made in the details within the scope and range of equivalents of the claims and without departing from the spirit of the invention. It will further be appreciated that the drawings are not rendered to any particular proportion or scale. The invention is not limited to any particular dimensions, materials, or other details of the illustrated embodiments.

What is claimed:

1. A positive displacement pump for an additive manufacture application, said pump comprising:
a motor having a rotatable output shaft;
at least one rotatable gear or rotatable screw that is attached to the output shaft of the motor; and
a passage defined downstream of said at least one rotatable gear or rotatable screw that is configured to receive material, cause heating of the material, and expel heated material out of the pump at a flow rate proportional to a rotation rate of the output shaft of the motor and at a constant flow rate for a fixed rotation rate of the output shaft regardless of changes in system pressure.

2. The positive displacement pump of claim 1, wherein the pump is configured such that heating of the material is completed in the passage and not on said at least one rotatable gear or rotatable screw.

3. The positive displacement pump of claim 1, further comprising a nozzle positioned at an outlet of the passage.

4. The positive displacement pump of claim 1, further comprising a heater for heating the passage and/or a housing for accommodating the at least one rotatable gear or the rotatable screw.

5. The positive displacement pump of claim 1, wherein the passage has a constant cross-section along its length.

6. The positive displacement pump of claim 1, further comprising a housing having a hollow region and positioned to surround the rotatable screw.

7. The positive displacement pump of claim 6, further comprising a guide positioned to direct the material into a gap defined between the rotatable screw and the housing.

8. The positive displacement pump of claim 1, wherein the pump is a gear pump having said at least one rotatable gear and a second rotatable gear that is meshed with said at least one rotatable gear.

9. The positive displacement pump of claim 1, wherein the rotatable screw has no more than 4 turns.

10. The positive displacement pump of claim 1, wherein the rotatable screw has a conical shape.

11. The positive displacement pump of claim 1, wherein a length (L) of the passage is given by the equation:
$$L = - \frac{1}{5.78 π} \frac{Q}{α} ln ( 1.45 \frac{{T}_{w} - 〈 T 〉}{{T}_{w} - {T}_{0}} ) ,$$
where Q is a volumetric flow rate of the material expelled from an outlet of the passage, α is a thermal diffusivity of the material, Tw is a wall temperature of the passage, <T> is an average temperature of the material expelled from the outlet of the passage, and To is the initial temperature of the material as it enters the passage.

12. A method of additive manufacture using a positive displacement pump including (i) a motor having a rotatable output shaft, (ii) at least one rotatable gear or rotatable screw that is attached to the output shaft of the motor, and (iii) a passage defined downstream of said at least one rotatable gear or rotatable screw, said method comprising:
introducing material onto or into said at least one rotatable gear or rotatable screw;
rotating said at least one rotatable gear or rotatable screw to deliver the material into the passage; and
expelling the material out of the pump at a flow rate proportional to a rotation rate of the output shaft of the motor and at a constant flow rate for a fixed rotation rate of the output shaft regardless of changes in system pressure.

13. The method of claim 12, wherein the material reaches a predetermined temperature when it is disposed within the passage, but not before.

14. The method of claim 12, wherein the heating step is performed by a heater.

15. The method of claim 12, wherein the pump is a gear pump having said at least one rotatable gear and a second rotatable gear that is meshed with said at least one rotatable gear.

16. The method of claim 12, wherein the rotatable screw has no more than 4 turns.

17. The method of claim 12, wherein a length (L) of the passage is given by the equation:
$$L = - \frac{1}{5.78 π} \frac{Q}{α} ln ( 1.45 \frac{{T}_{w} - 〈 T 〉}{{T}_{w} - {T}_{0}} ) ,$$
where Q is a volumetric flow rate of the material expelled from an outlet of the passage, a is a thermal diffusivity of the material, Tw is a wall temperature of the passage, <T> is an average temperature of the material expelled from the outlet of the passage, and To is the initial temperature of the material as it enters the passage.

18. A positive displacement pump for an additive manufacture application, said pump comprising:
a motor having a rotatable output shaft;
at least one rotatable gear or rotatable screw that is attached to the output shaft of the motor; and
a passage defined downstream of said at least one rotatable gear or rotatable screw that is configured to receive material, and expel the material out of the pump at a flow rate proportional to a rotation rate of the output shaft of the motor and at a constant flow rate for a fixed rotation rate of the output shaft regardless of changes in system pressure.

19. The positive displacement pump of claim 18, wherein for solidifying the material expelled from the passage, the pump further comprises one of: a (i) UV emitter, radiation emitter or light source positioned at an outlet of said passage for curing the material expelled from the outlet of the passage, (ii) a means positioned at the outlet of the passage for cooling or freezing the expelled material to cure the expelled material, (iii) a heater or heated substrate positioned at the outlet of the passage to cure the expelled material, and (iv) a gas source positioned at the outlet of the passage to cure the expelled material.

20. The positive displacement pump of claim 18, further comprising a static mixer positioned within the passage for mixing the material to make a homogenous mixture prior to deposition.
